(19) United States
(12) Patent Application Publication
(10) Pub. No.: US 2025/0263054 A1
(43) Pub. Date: Aug. 21, 2025

(54) HYDRAULIC BLOCK OF A POWER BRAKE SYSTEM

(71) Applicant: Robert Bosch GmbH, Stuttgart (DE)

(72) Inventors: Andreas Weh, Sulzberg (DE); Martin Hagspiel, Rettenberg (DE); Matthias Mayr, Rettenberg (DE); Stefan Kaserer, Ofterschwang (DE)

(21) Appl. No.: 18/857,363

(22) PCT Filed: May 19, 2023
(86) PCT No.: PCT/EP2023/063458

§ 371 Date: Oct. 16, 2024

(30) Foreign Application Priority Data
Jul. 28, 2022 (DE) 10 2022 207 785.7

(51) Int. Cl. B60T 13/14; B60T 13/68; B60T 13/74

(52) U.S. Cl. CPC B60T 13/14; B60T 13/686; B60T 13/745

(57) ABSTRACT

A hydraulic block of a power brake system, which is designed as a cuboidal housing block. The hydraulic block has a power cylinder bore for receiving a power cylinder, and two chambers, which are arranged above the power cylinder bore and form a brake fluid reservoir. On a side of the power cylinder bore that is opposite to the brake fluid reservoir, a separating cylinder is arranged, which extends perpendicularly to the power cylinder bore and in which a separating piston is arranged, which hydraulically separates a first and a second supply connection to a vehicle dynamics control from one another. The separating cylinder is hydraulically connected to the power cylinder so that pressure of the power cylinder can be applied to a first axial piston side of the separating piston and a brake pressure can be generated via a second axial piston side of the separating piston.

### FIELD

The present invention relates to a hydraulic block of a power brake system. Moreover, the present invention relates to a master-brake-cylinder-free brake system comprising such a hydraulic block.

### BACKGROUND INFORMATION

German Patent Application No. DE 10 2018 220 573 A1 relates to a hydraulic block for a hydraulic unit of a hydraulic vehicle power brake system. The hydraulic block has a power cylinder bore orthogonal to the master brake cylinder bore and a receptacle for a pedal travel simulator. The receptacle for the pedal travel simulator is attached in parallel with the power cylinder bore in the hydraulic block.

German Patent Application No. DE 10 2017 204 407 A1 describes a hydraulic block for a hydraulic vehicle power brake system. Connections for wheel brakes are attached along a transverse side with connections for a brake fluid storage container or along a longitudinal side in a large side of the hydraulic block.

### SUMMARY

An object of the present invention is to provide a hydraulic block of a power brake system that requires reduced installation space and is economical to produce.

The object may be achieved by a hydraulic block for a power brake system with certain features of the present invention. Advantageous developments and example embodiments of the present invention are disclosed herein.

The present invention provides a hydraulic block of a power brake system, which is designed as a cuboidal housing block. The hydraulic block has a power cylinder bore for receiving a power cylinder, and two chambers, which are arranged above the power cylinder bore and form a brake fluid reservoir.

According to an example embodiment of the present invention, the cuboidal housing block is preferably formed from an extruded aluminum block. Such an extruded aluminum block is simple and cost-effective to produce so that the costs of such a hydraulic block can be kept low. The weight for the hydraulic block can be reduced by using aluminum or an aluminum alloy. The first and the second chamber of the brake fluid reservoir are formed in the housing so that no further attachment parts are necessary and installation space can be saved.

On a side of the power cylinder bore that is opposite to the brake fluid reservoir, a separating cylinder is arranged, which extends perpendicularly to the power cylinder bore and in which a separating piston is arranged, which hydraulically separates a first and a second supply connection to a vehicle dynamics control from one another. The power cylinder bore advantageously extends in the thickness direction of the hydraulic block, while the separating cylinder extends in the longitudinal direction. Due to the larger length of the separating cylinder in comparison to the power cylinder bore, the thickness of the hydraulic block does not have to be increased due to the perpendicular arrangement of the separating cylinder so that the installation space required for the hydraulic block can be kept low. By disconnecting the supply connections, the separating cylinder can provide the necessary safety so that, if one brake circuit leaks, the other brake circuit remains operable. The separating cylinder additionally has the advantage that, contrary to other circuitry, which comprises a separate separating valve for separating a brake circuit, only a single separating cylinder is necessary for the separation. This can again reduce installation space for such a hydraulic block.

The separating cylinder is hydraulically connected to the power cylinder so that pressure of the power cylinder can be applied to a first axial piston side of the separating piston and a brake pressure can be generated via a second axial piston side of the separating piston. The separating cylinder thus serves not only to separate the brake circuits but also to build pressure in one of the circuits.

According to an example embodiment of the present invention, particularly preferably, the hydraulic block is designed to be master-cylinder-free. In other words, this means that no master brake cylinder actuated by a brake pedal is arranged in the hydraulic block. Through a hydraulic block designed in this way, the space for a master cylinder can thus be saved so that the components and the installation space for such a hydraulic block can be reduced significantly and the hydraulic block can be produced economically.

In a preferred embodiment of the present invention, the first axial piston side of the separating piston is designed such that, when this piston side abuts against a separating cylinder base, a portion of this piston side is spaced apart from the separating cylinder base. The piston side thus abuts only partially against the separating cylinder base. Such a design results in the formation of a space, in which brake fluid is arranged, between the piston side and the separating cylinder base. The pressure of this brake fluid can thus continue to act on a portion of the piston surface in order to be able to move it in the separating cylinder. Advantageously, the piston side is provided with a central extension that abuts against the separating cylinder base.

In a further preferred embodiment of the present invention, an EMC contact for a controller is provided via a cover of the power cylinder. No separate EMC (electromagnetic compatibility) contact is thus provided. The EMC contact is thus formed by the already present cover of the power cylinder. The cover of the power cylinder thus directly fulfills multiple functions. Space for a separate EMC contact can thus be saved so that the size of the hydraulic block can be reduced.

Preferably, electrical contacts for a controller and a switching valve for switching a connection between the first chamber of the brake fluid reservoir and the first supply connection are arranged in the area of a quadrant around a cover of the power cylinder. Both the electrical contacts and the switching valve are connected to a printed circuit board of the controller. Particularly preferably, a rotor sensor contact is also arranged in the area of the quadrant. These contacts and the switching valve are arranged in a limited area. In comparison to an arrangement in which the contacts are distributed over the entire side of the hydraulic block, the size of the printed circuit board and thus also the size of the controller can be reduced so that the installation space required for the hydraulic block can be kept low as a result of such an arrangement.

In an advantageous development of the present invention, the electrical contacts for the controller and the switching valve are arranged on a side of the power cylinder that faces toward an electrical plug of the controller. The printed circuit board of the controller is connected to both the electrical plug and the contacts. The distance between the electrical plug and the contacts can be minimized by a corresponding arrangement of the contacts. The printed circuit board thus only has to have a length between the contacts and the electrical plug. This makes it possible to further reduce the size of the printed circuit board and thus the size of the controller.

Advantageously, an undercut, via which the switching valve is connected to the first chamber of the brake fluid reservoir, is formed at the power cylinder bore. The undercut is designed as a limited area with a larger diameter than the core diameter of the power cylinder bore. As a result, a hydraulic line is formed, by means of which the brake fluid can be directed around the power cylinder bore. A displacement of the power cylinder bore to form a hydraulic bore is thus not necessary. As the entire hydraulic block is enlarged by such a displacement, a compact and space-saving form for the hydraulic block can be maintained through such an undercut.

In a further advantageous embodiment of the present invention, the separating piston has at least one through-hole via which a supply connection for the vehicle dynamics control is connected to the second chamber of the brake fluid reservoir in a home position of the separating piston. In order to bring the separating piston into a home position, at which a portion of the piston side abuts against the separating cylinder base, a separating piston spring is advantageously arranged on an opposite piston side. This home position is thus assumed by the separating piston spring when the piston side facing away from the separating piston spring is pressure-less. For connecting the second chamber of the brake fluid reservoir to the supply connection for the vehicle dynamics, the separating cylinder is connected to the brake fluid reservoir via a hydraulic line. In the home position, it is thus possible for the vehicle dynamics control to be supplied with brake fluid from the brake fluid reservoir through the through-hole in the separating piston. The through-hole in the separating piston, which advantageously interacts with seals, thus simultaneously forms a valve between the brake fluid reservoir and the vehicle dynamics control. The separating cylinder thus has multiple functions so that the number of components is reduced and installation space is saved.

According to an expedient embodiment of the present invention, the hydraulic block forms two supply connections for a vehicle dynamics control, which are oriented toward the controller and arranged vertically one above the other. The vertical arrangement of the supply connections results in a space-saving arrangement of these connections in the hydraulic block so that the width of the hydraulic block does not need to be increased.

According to a further expedient embodiment of the present invention, the switching valve and the power cylinder are connected to a supply connection for a vehicle dynamics control via a common horizontal connection bore. As a result, it is not necessary to provide a separate bore for both the switching valve and the power cylinder. This reduces the production time.

Space is also not required for this separate additional bore, so the hydraulic block requires less installation space.

The present invention additionally specifies a master-brake-cylinder-free brake system comprising the hydraulic block according to the present invention. A master-brake-cylinder-free brake system has the advantage that space for a master cylinder and the hydraulic lines required for it can be saved so that the entire brake system requires less space. Such a brake system also offers the advantages already mentioned with regard to the hydraulic block.

Embodiment examples of the present invention are shown in the figures and explained in more detail in the following description.

### BRIEF DESCRIPTION OF THE DRAWINGS

FIG. 1 shows a brake system according to an embodiment example of the present invention.

FIG. 2 shows an exploded view of an embodiment example of a hydraulic block, according to the present invention.

FIG. 3 shows a front view of an embodiment example of the hydraulic block, according to an example embodiment of the present invention.

FIG. 4 shows a perspective view of the hydraulic block shown in FIG. 2.

FIG. 5 shows a sectional representation of an embodiment example of the separating cylinder with a separating piston, according to the present invention.

### DETAILED DESCRIPTION OF EXAMPLE EMBODIMENTS

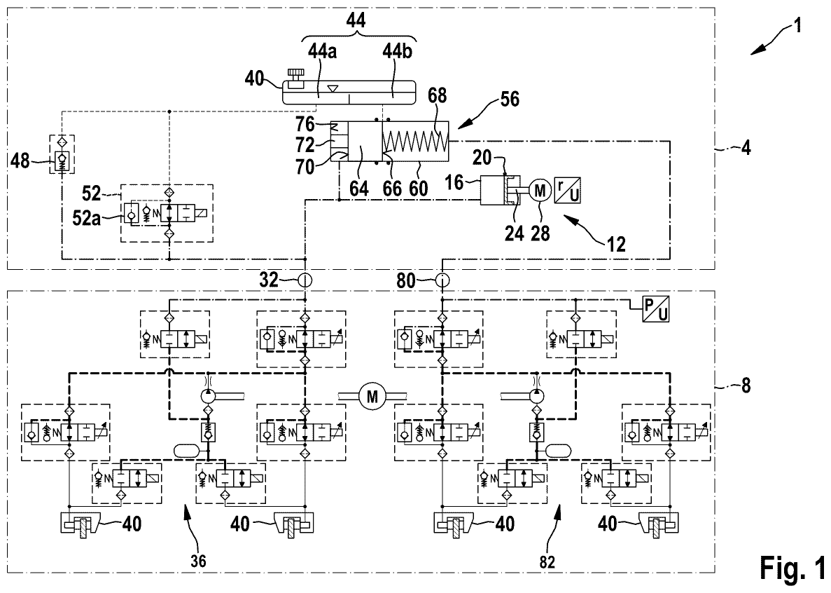

FIG. 1 shows a brake system 1 according to an embodiment example of the present invention. The brake system 1 comprises two units 4, 8. A first unit 4 comprises a power brake pressure generator 12 with a power cylinder 16, in which a power piston 20 can be moved, and a spindle drive assembly 24. The spindle drive assembly 24 is connected to a motor 28 of the power brake pressure generator 12, via which a rotational movement of the spindle drive assembly 24 is converted into a translational movement of the power piston 20. A brake pressure is provided at a first supply connection 32 via the translational movement of the power piston 20. A first brake circuit 36 of the second unit 8 designed as a vehicle dynamics control is connected to this first supply connection 32. This brake pressure is used to actuate two wheel brakes 40 of the first brake circuit 36.

The first unit 4 additionally comprises a brake fluid reservoir 44, which is divided into two chambers 44a, 44b. A first chamber 44a of the brake fluid reservoir 44 is connected to the power cylinder 16 and the first supply connection 32 via a check valve 48 that closes the first chamber 44a. Parallel to the check valve 48, a 2/2-way switching valve 52 is arranged, which is open in a currentless state. The switching valve 52 is additionally formed with a switching check valve 52a blocking in the direction of the brake fluid reservoir 44.

Moreover, the first unit 4 comprises a separating valve 56 supplied with brake fluid via the second chamber 44b of the brake fluid reservoir 44. The separating valve 56 comprises a separating cylinder 60 and a separating piston 64 which can be moved in the separating cylinder 60. A separating piston spring 68 is arranged on a second axial piston side 66 and pushes the separating piston 64 in one direction. The separating piston 64 additionally has a separating piston extension 72 on a piston side facing away from the separating piston spring 68, so that a first axial piston side 70 of the separating piston 64 does not abut flush against a separating cylinder base 76.

On a side of the separating cylinder 60 on which the separating piston spring 68 is arranged, the separating cylinder is hydraulically connected to a second supply connection 80. The first axial piston side 70 is connected to both the power brake pressure generator 12 and the first supply connection 32. When a pressure is generated on the first axial piston side 70 by the power brake pressure generator 12, the separating piston 64 is moved toward the separating piston spring 68 so that a brake pressure is also generated at the second supply connection 80 via the second axial piston side 66 in addition to the pressure at the first supply connection 32. A brake pressure can thereby be generated in the second brake circuit 82 of the second unit 8.

The second unit 8 shown in FIG. 1 shows a conventional vehicle dynamics control, such as an ESP control, which is not described further here.

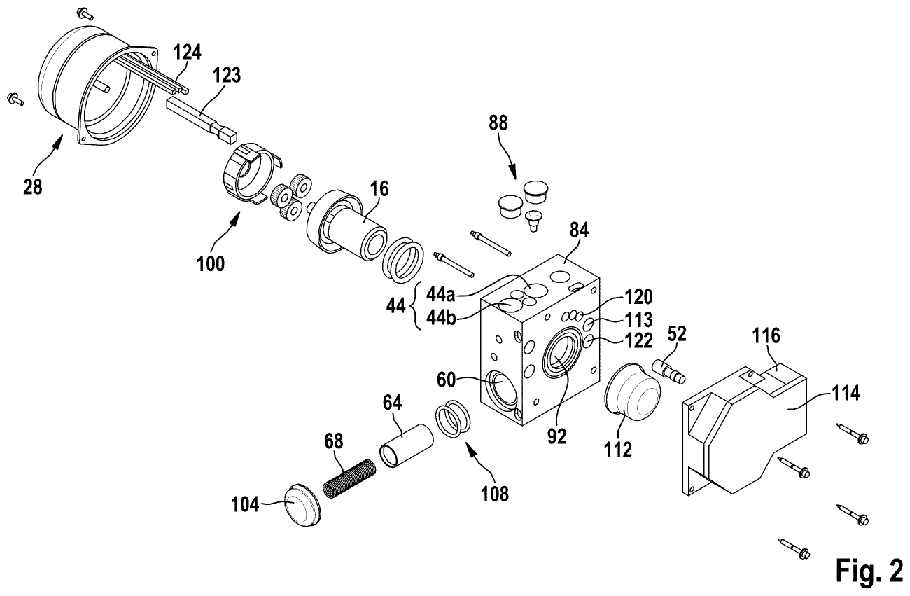

FIG. 2 shows an exploded view of an embodiment example of a hydraulic block 84. The first unit 4 is formed entirely by this hydraulic block 84. The first and second chambers 44a, 44b of the brake fluid reservoir 44 are arranged on a top side of the hydraulic block 84. These chambers 44a, 44b are sealed via sealing plugs 88. A power cylinder bore 92, which receives the power cylinder 16, is arranged centrally in the thickness direction in the hydraulic block 84. The power piston 20 in the power cylinder 16 can be moved axially in the power cylinder 16 via a gear mechanism 100 that can be driven by the motor 28.

The separating cylinder 60 is additionally formed in the hydraulic block 84. This separating cylinder 60 is arranged on the opposite side of the power cylinder bore 92 to the brake fluid reservoir 44 so that the separating cylinder 60 is located below the power cylinder bore 92. The separating cylinder 60 is perpendicular to the power cylinder bore 92. The separating piston 64, which can be moved in an axial direction of the separating cylinder 60, is arranged in the separating cylinder 60. Between a separating cylinder cap 104 and the separating piston 64, the separating piston spring 68 is arranged, via which the separating piston 64 is acted upon by a spring force in a direction facing away from the separating cylinder cap 104. For sealing the separating piston 64 in the separating cylinder 60, two seals 108 are additionally arranged in the separating cylinder 60.

A cover 112 of the power cylinder 16, with which said power cylinder can be closed, is arranged on a side of the hydraulic block 84 that is opposite to the motor 28. The switching valve 52, which is received in a correspondingly formed switching valve bore 113 in the hydraulic block 84, is additionally attached to this side. The cover 112 and the switching valve 52 protrude into a controller 114 arranged on this side. The controller 112 comprises an electrical plug 116, via which the controller 114 is contacted and which protrudes laterally from the hydraulic block 84 when the controller 114 is mounted.

In the area of the switching valve 52 around the power cylinder 16, the hydraulic block 84 forms additional contact bores 120, via which electrical contacts 124 for the motor 28 can be connected to the controller 114 by the hydraulic block 84. Additionally, in the area of the switching valve 52 around the power cylinder 16, a rotor sensor contact bore 122 is arranged, via which a rotor sensor contact 123 is connected to the controller 114. The contact bores 120, the switching valve bore 113, and the rotor sensor contact bore 122 are arranged in this embodiment example in a quadrant around the cover 112 of the power cylinder 16. In particular, the contact bores 120 and thus the contacts 124, the rotor sensor contact 123, and the switching valve 52 are arranged on a side of the power cylinder bore 92 that faces the electrical plug 116 of the switching device 114. Moreover, the first and second supply connections 32, 80 are arranged on the side of the controller 114.

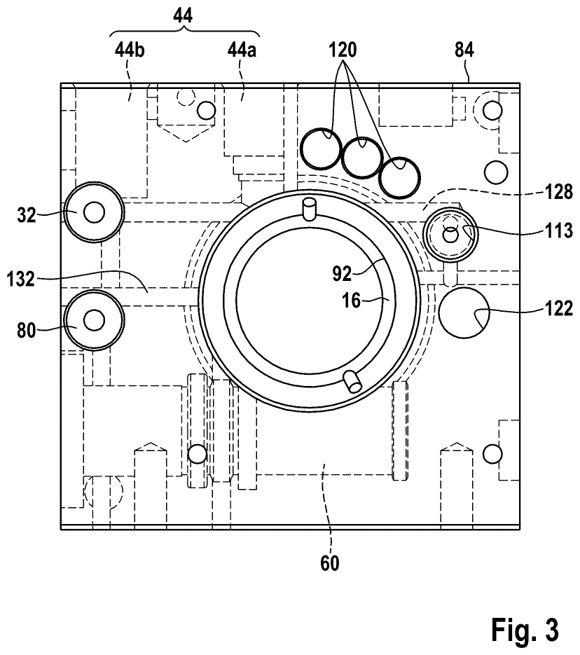

FIG. 3 shows a front view of an embodiment example of the hydraulic block 84. This embodiment example shows how the components and the hydraulic lines are arranged in the hydraulic block 84. A horizontal connection bore 128 connects the switching valve 52 and the power cylinder 16 to the first supply connection 32 for the vehicle dynamics control 8. In the embodiment example shown in FIG. 3, the supply connections 32, 80 for the vehicle dynamics control are arranged vertically one above the other and oriented toward the controller 114. The supply connections 32, 80 and the contact bores 120 are arranged on two sides opposite to the power cylinder bore 92. For supplying brake fluid to the separating cylinder 60, a supply line 132, formed via vertical and horizontal bores, is formed in the hydraulic block 84 and connects the second chamber 44b of the brake fluid reservoir 44 to the separating cylinder 60.

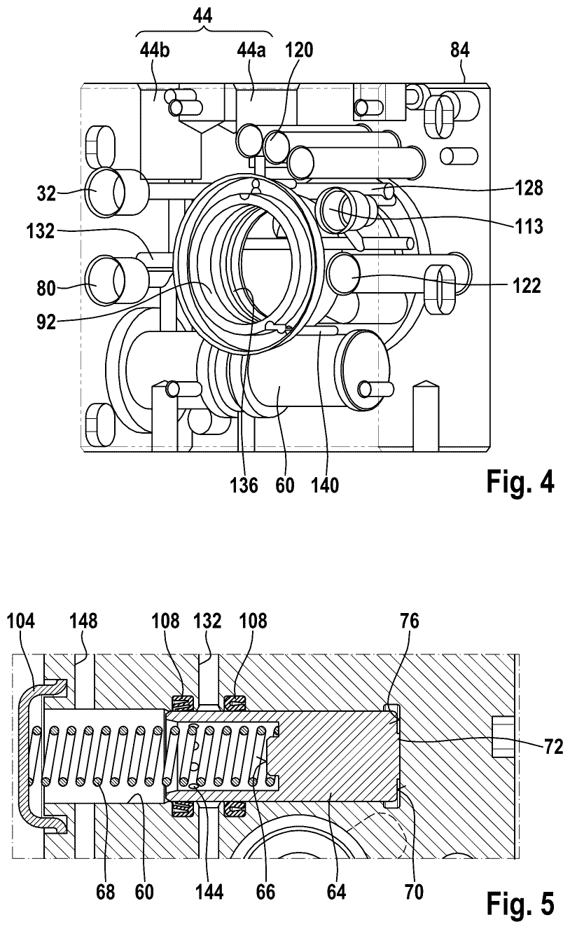

FIG. 4 shows a perspective view of the hydraulic block 84 shown in FIG. 2. In this figure, it can be seen that an undercut 136, via which the switching valve bore 113 is connected to the first chamber 44a of the brake fluid reservoir 44, is formed in the power cylinder bore 92. It is additionally shown that the power cylinder bore 92 is connected to a rear region of the separating cylinder 60 via a frontal bore 140.

A sectional representation of an embodiment example of the separating cylinder 60 with a separating piston 64 is shown in FIG. 5. The separating piston 64 is pushed toward the separating cylinder base 76 via the separating piston spring 68 arranged between the separating piston 64 and the separating cylinder cap 104. On a side facing the separating cylinder base 76, the separating piston 64 has the central separating piston extension 72, via which the separating piston 64 does not abut flush against the separating cylinder base 76. As a result, a pressure of the power cylinder 16 that acts in the area of the separating cylinder base 76 can continue to act on the separating piston 64 so that said separating piston is displaced toward the separating cylinder cap 104.

The supply line 132 connected to the brake fluid reservoir 44 is arranged in the area of a center of the separating cylinder 60 so that it is connected to the separating cylinder 60 in the area of the separating piston 64. On both sides of the supply line 132, the seals 108 abut against the separating piston 64 so that the rest of the separating cylinder 60 is sealed toward the supply line 132. The separating piston 64 has circumferential through-holes 144 that lie between the two seals 108 in a home position, in which the separating piston 64 abuts against the separating cylinder base 76. As a result, a connection between the supply line 132 and a supply connection bore 148 leading to the second supply connection 80 is free in the home position.

This connection is closed as soon as the separating piston 64 is moved toward the separating cylinder cap 104 via the pressure of the power cylinder 16. The separating piston 64 thereby simultaneously forms a valve.

1-10. (canceled)

11. A hydraulic block of a power brake system, comprising:
a cuboidal housing block including a power cylinder bore configured to receive a power cylinder, and two chambers, which are arranged above the power cylinder bore and form a brake fluid reservoir;
wherein, on a side of the power cylinder bore that is opposite to the brake fluid reservoir, a separating cylinder is arranged, which extends perpendicularly to the power cylinder bore and in which a separating piston is arranged, which hydraulically separates a first and a second supply connection to a vehicle dynamics control from one another, wherein the separating cylinder is hydraulically connected to the power cylinder so that pressure of the power cylinder can be applied to a first axial piston side of the separating piston and a brake pressure can be generated via a second axial piston side of the separating piston.

12. The hydraulic block according to claim 11, wherein the first axial piston side of the separating piston is configured such that, when the first axial piston side abuts against a separating cylinder base, a portion of the first axial piston side is spaced apart from the separating cylinder base.

13. The hydraulic block according to claim 11, wherein an EMC contact for a controller is provided via a cover of the power cylinder.

14. The hydraulic block according to claim 11, wherein electrical contacts for a controller and a switching valve for switching a connection between a first chamber of the two changes of the brake fluid reservoir and the first supply connection are arranged in an area of a quadrant around a cover of the power cylinder.

15. The hydraulic block according to claim 14, wherein the electrical contacts for the controller and the switching valve are arranged on a side of the power cylinder that faces an electrical plug of the controller.

16. The hydraulic block according to claim 14, wherein an undercut, via which the switching valve is connected to the first chamber of the brake fluid reservoir, is formed at the power cylinder bore.

17. A hydraulic block according to claim 11, wherein the separating piston has at least one through-hole, via which a supply connection for the vehicle dynamics control is connected to a second chamber of the two chambers of the brake fluid reservoir in a home position of the separating piston.

18. The hydraulic block according to claim 11, wherein the hydraulic block forms two supply connections for the vehicle dynamics control which are oriented toward the controller and arranged vertically one above the other.

19. The hydraulic block according to claim 11, wherein the switching valve and the power cylinder are connected to a supply connection for the vehicle dynamics control via a common horizontal connection bore.

20. A master-brake-cylinder-free brake system, comprising:
a hydraulic block of a power brake system, including:
a cuboidal housing block including a power cylinder bore configured to receive a power cylinder, and two chambers, which are arranged above the power cylinder bore and form a brake fluid reservoir,
wherein, on a side of the power cylinder bore that is opposite to the brake fluid reservoir, a separating cylinder is arranged, which extends perpendicularly to the power cylinder bore and in which a separating piston is arranged, which hydraulically separates a first and a second supply connection to a vehicle dynamics control from one another, wherein the separating cylinder is hydraulically connected to the power cylinder so that pressure of the power cylinder can be applied to a first axial piston side of the separating piston and a brake pressure can be generated via a second axial piston side of the separating piston.
